(19) United States
(12) Patent Application Publication
(10) Pub. No.: US 2004/0225575 A1
(43) Pub. Date: Nov. 11, 2004

(54) SYSTEM AND METHOD TO PURCHASE A CUSTOMIZED CD, DVD AND THE LIKE

(76) Inventors: David M. List, Lansnig, MI (US); Marianne List, Lansing, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/604,924

(22) Filed: Aug. 27, 2003

Related U.S. Application Data
(60) Provisional application No. 60/469,328, filed on May 9, 2003.

(51) Int. Cl. G06F 17/60

(52) U.S. Cl. 705/26

(57) ABSTRACT

A system for selectively storing recorded material onto a storage medium such as a compact disc (CD) or digital video disc (DVD) includes a terminal having access to recorded material and configured to download recorded material selected by a user to a storage medium, and a dispenser connected to the terminal configured to distribute the storage medium to a user. A method of purchasing a customized storage medium, such as a CD or DVD includes the steps of accessing a terminal; selecting at least one recorded item; adding the at least one recorded item to a list; recording the at least one item to the storage medium; placing the storage medium in a case and dispensing the storage medium to a user. The system and method may also include storing sales data on a server and accessibility of the sales data on the server by a third party.

### CROSS REFERENCE TO RELATED APPLICATIONS

This application claims priority to United States provisional application Ser. No. 60/469,328 entitled “System and Method to Purchase a Customized CD, DVD and the Like,” filed May 9, 2003.

### BACKGROUND OF INVENTION

1. Field of the Invention

The present invention generally relates to a system and method for purchasing recorded material and in particular to a system and method of custom designing a compact disc (CD), digital video disc (DVD), and the like, having selected recorded material, such as music, music video, recorded books, videos/movies, and video games recorded thereon.

2. Description of Related Art

Music, books, movies and other forms of audio/visual entertainment (collectively referred to as “recorded material”) are commonly recorded onto media such as compact discs (CDs) or digital video discs (DVDs), which may be purchased by a consumer. Many methods are available to acquire these recorded materials. In addition to traditional retail purchase of recorded material, it is also available for purchase through mail order, telephone or internet processes.

Traditionally, recorded material is purchased on a storage medium with a specific content compilation designed by the manufacturer. Consumers may also purchase individual items of recorded material. Often this involves separate individual purchases with no opportunity for the user to create their own specific content compilation. One possible method to obtain individual recorded materials and compile them onto one recorded medium is through internet sales websites by either mail order or immediate download. Current MP3 compression technology has made internet recorded material downloading and uploading a popular way to acquire and distribute recorded materials. Unfortunately, the download of material through the internet has often resulted in copyright infringement issues and subsequent litigation.

There are currently no known methods available to allow a user to custom design recorded materials having only desired songs, movies or other material individually selected and compiled on a single medium (such as a CD or DVD). Further, not all consumers own a computer or have internet access, and not all computers have capabilities to allow them to make purchases through the internet then copy them to a CD and/or DVD player. Thus there is a desire and need in the art to provide a system and method that allows consumers to design and create a CD, DVD or other like storage medium, having selected recorded materials recorded thereon. Such a system could utilize or combine internet and point of purchase locations such as retail stores, kiosks and the like.

### SUMMARY OF INVENTION

Accordingly, the present invention provides a system and method of designing and creating a customized CD, DVD or other medium of storage having selected recorded materials recorded thereon. The present invention may be practiced by accessing the internet from a user's computer or at a point of purchase location.

In one embodiment of the present invention, a method of purchasing a customized CD, DVD or other like storage medium includes the steps of accessing a terminal, the terminal having access to at least one recorded item and including at least one storage medium; selecting at least one of the at least one recorded item; adding the at least one recorded item to a list; recording the at least one item to the storage medium; and dispensing the storage medium.

In another embodiment of the present invention, a system for selectively storing audio and visual recorded material onto a storage medium includes a terminal having access to recorded material and configured to download selected recorded material to a storage medium selected by a user and a dispenser connected to the terminal configured to distribute the selected storage medium with the recorded material thereon.

In yet another embodiment of the present invention, a method of purchasing recorded material includes the steps of: selecting at least one recorded item from a list of recorded items available for purchase; purchasing said at least one recorded item; collecting sales data on a server related to the quantity of sales of said at least one recorded item; communicating said data to an internet website; and accessing said data to determine applicable royalty payments.

Other features of the present invention will become more apparent to persons having ordinary skill in the art to which the present invention pertains from the following description and claims taken in conjunction with the accompanying figures.

### BRIEF DESCRIPTION OF DRAWINGS

The foregoing features, as well as other features, will become apparent with reference to the description and figures below, in which like numerals represent like elements, and in which:

FIG. 1 is a block diagram of the systems of the present invention;

FIG. 2 is a perspective view of a remote terminal of the present invention;

FIG. 3 is a flow diagram of a method of the present invention; and

FIG. 4 is an illustration of a disc case and disc of the present invention.

### DETAILED DESCRIPTION

The present invention generally relates to a system and method for custom designing and acquiring a compact disc (CD), digital video disc (DVD), or other storage medium having selected prerecorded music, movies, books and the like (collectively referred to as “recorded material”) recorded thereon. A terminal having access to such recorded material may be publicly accessible in the form of a kiosk or vending machine, in places such as malls, airports, gas stations and the like. Alternatively, the terminal may be located within a retail establishment. A user may access the terminal and preview and select recorded materials that may be compiled and stored onto a storage medium such as a CD, DVD, MP3 and the like. The recorded material may include music, music video, recorded books, video movies, video games, and the like. The user may pay directly at the terminal and the storage medium may be dispensed to the user. Alternatively, if the terminal is located within a retail establishment, the storage medium may be dispensed to the user to take to a cashier to complete the purchase.

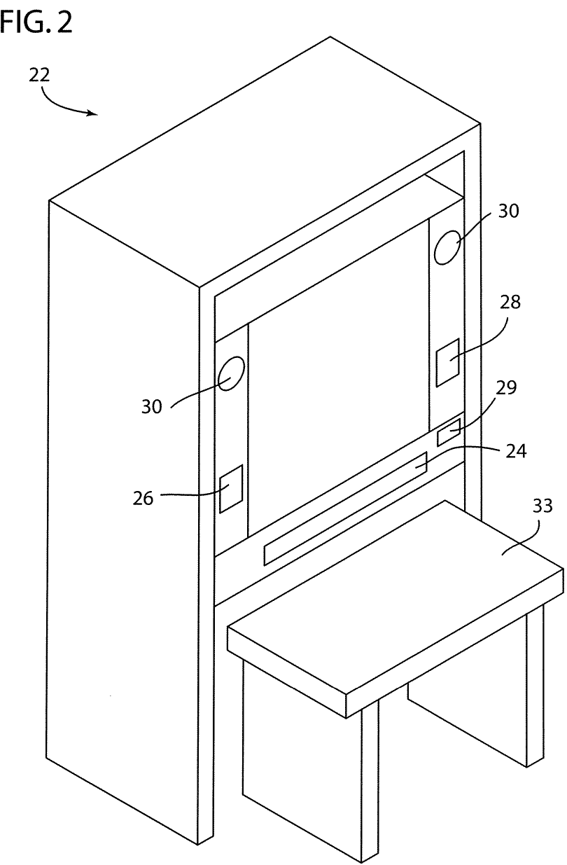

Referring now to the figures, a system 20 of the present invention may include a terminal 22 that may be a remote public access computer similar to a vending machine or located in a kiosk, or may be a stand alone terminal located within a retail establishment as illustrated in FIG. 2. The user may access terminal 22 and participate in interactive communication with terminal 22 through menu driven software. The terminal 22 may include touch screen technology to allow the user to easily navigate through the software programs. Alternatively, the computer may utilize mechanical controls, such as button controls, located within terminal 22 and well known in the art.

Terminal 22, as illustrated in FIG. 2, includes a dispenser unit 24 for dispensing the storage medium created by the user (such as CD or DVD), a credit card/debit card acceptor unit 26, a cash acceptor unit 28, a receipt dispenser 29 and speakers 30. Speakers 30 enable the user to receive audio prompts or listen to previews of selected recorded material. Credit card/debit card acceptor 26 may be a standard credit card swipe device similar to those used at gas pumps or other self serve checkout stations. Likewise, cash acceptor 28 may be a cash acceptor and change dispenser device available in the art and commonly used for change machines. Terminal 22 may also include a seat or bench 33 to enable the user to sit comfortably at terminal 22 during operation of the programs.

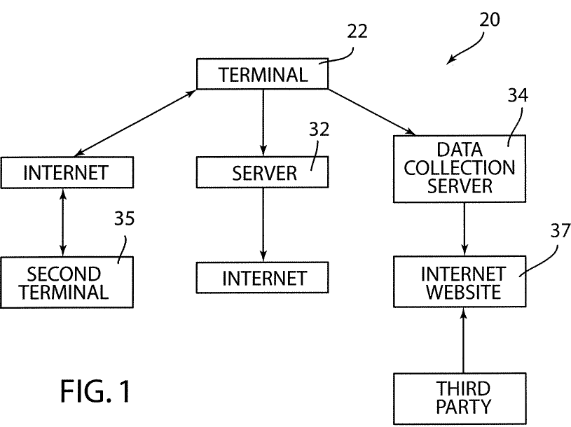

Terminal 22 may include its own hard drive for storing recorded material and may also be communicatively connected to a supply server 32 as shown in FIG. 1. Supply server 32 may be located within the retail establishment, or at some other remote location. Supply server 32 may provide greater capacity, and access to a larger number of recorded materials to be made available for selection by a user. Both terminal 22 and supply server 32 may also be communicatively connected to the internet to provide even greater capacity and access to more recorded materials for the user to select from and add to their custom designed CD, DVD, and the like. The additional recorded materials may also be stored and available through a second terminal 35. Second terminal 35 may be connected to terminal 22 through the internet or directly through communication between terminal 22 and second terminal 35. These combinations of recorded material resources will increase the versatility and desirability of the present invention.

System 20 may also include a data collection server 34, either included within terminal 22 or communicatively connected to terminal 22. Data collection server 34 may also have the capability to collect sales data and other information for each recorded material item selected and purchased by a consumer. This data collection may include an accurate account of royalties that may need to be paid to copyright holders of the recorded material selected and purchased by a user. Data collection server 34 may collect and compile such data as sales volumes and sales dollars, which may also aid in determining royalty amounts owed to owners of rights in the recorded materials sold. Data collection server 34 may also be communicatively connected to the internet, which will enable third parties, such as copyright holders, to access the information stored on data collection server 34 and obtain up to date information on sales volumes and royalty amounts. Programs may also be incorporated to calculate royalty amounts for a particular copyright owner based on the sales of their copyrighted recorded material. Data collection server 34 may be accessed directly by an authorized user. Alternatively, data collection server 34 may communicate information to a special secure website 37 designed to allow access only to specific authorized third parties and may limit the type of access for a given authorized third party. For example, a particular copyright holder may have access only to information pertaining to sales of recorded material containing its copyrighted work.

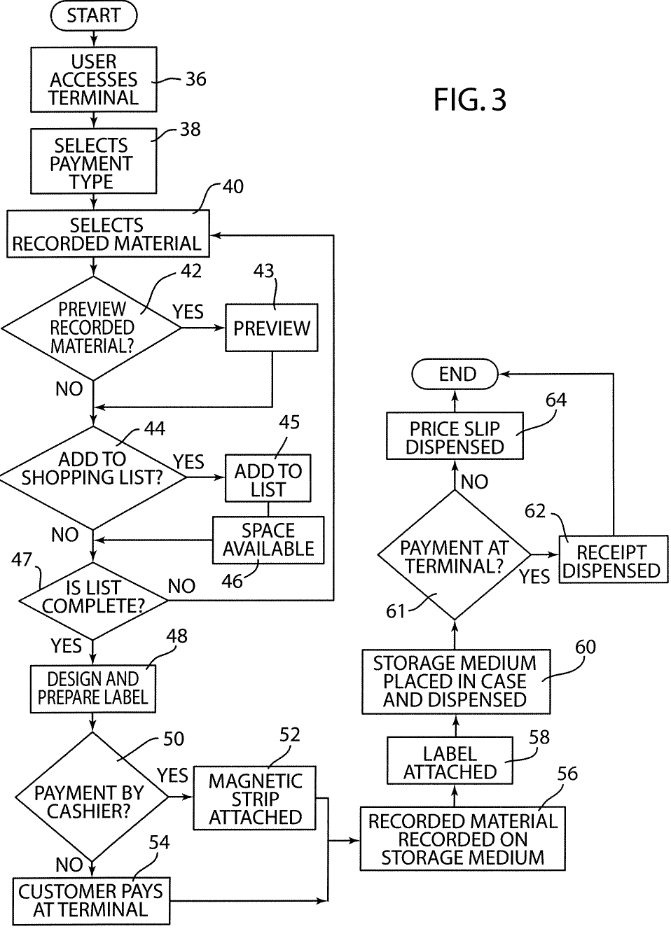

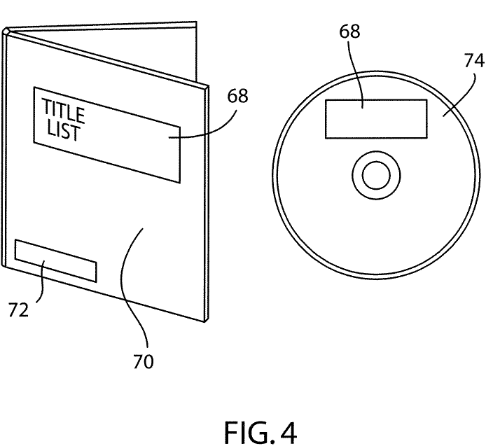

By way of example, a flow diagram of one possible method of using remote terminal 22 is shown in FIG. 3. The method may start at step 36 where the user may access terminal 22. The terminal screen may provide instructions to the user on how to operate terminal 22. Next the user may then be requested to select a payment type, at step 38. Such payment may be made using a credit card, automatic debit, or cash at terminal 22, or other payment means known in the art. An option may also be available to allow a customer to select “cashier” payment, if terminal 22 is located within a retail establishment where a cashier is available. If cashier payment is selected, a later action will be required by terminal 22 to attach a commercially available magnetic security strip 72 to a case 70 for which the storage medium will be placed to protect against theft (see FIG. 4).

Next, the user may then select recorded material (step 40), which may include music, music video, recorded books, video recordings and video games, depending on what has been purchased and licensed by the terminal owner. A list of possible recorded material selections in various categories may be provided. The user may be given further selection instructions to help the user search for desired recorded material within each category. The user may search for recorded material by entering search terms such as artist name, song title, recording year, key words from lyrics and the like. When making a selection, the user may be informed of the amount of space the selection will use on the particular storage medium to help the user determine which items to add to its shopping list. In some cases, the selected recorded material may require more space than one single storage medium can hold. In such a case, the user may be informed of the costs to purchase the selected recorded material based on the number of the particular storage mediums required.

At step 42, the user may be prompted to select whether he wants to preview the selected recorded material. If YES, the system proceeds to step 43 and provides a brief sample of the recorded material selected that the user can listen to or view. If NO, the user may continue reviewing the list of available recorded material. After the user has either selected an item, or previewed one, the user may then be asked whether he would like to add the selected recorded material item to a shopping list at step 44. If YES, the selected recorded material item will be added to the shopping list at step 45. The shopping list will include the recorded material to be recorded on the particular storage medium to be purchased. At step 46, the program may also inform the user as to the available space remaining on the storage medium after each addition of recorded material to the storage medium. After step 44, 45 and 46 the system proceeds to step 47, which may include asking the user whether the shopping list is complete. If the answer to step 47 is NO, the user may be instructed to continue with the selection process at step 40. If the answer to step 47 is YES, the system proceeds to step 48 where the user may design a personalized label 68 and the system prints the label 68 to be affixed to case 70. Case 70 may be a protective case for storage medium 74 as shown in FIG. 4. Alternatively, label 68 may be affixed directly on the storage medium 74, also shown in FIG. 4. The label 68 may include a variety of information including, but not limited to, a title, selected from a preexisting list or designed by the user, and the list of recorded material items selected and recorded on the storage medium 74 (See FIG. 4).

Once the label has been created, the system proceeds to step 50 where the user is prompted to make a determination as to whether or not the payment type selected at step 38 was “cashier payment.” If cashier payment was selected (i.e., YES), the system may affix magnetic security strip 72 to case 70 at step 52 then proceed to step 56. If the user selects NO at step 50, the user then pays for the customized storage medium (CD, DVD, and the like) at the terminal (step 54) then proceeds to step 56. At step 56, the system then records the selected recorded material items onto the storage medium. At step 58, label 68 may then be attached to case 70 or to storage medium 74, whichever was selected at step 48. At step 60, the system may place storage medium 74 inside case 70 and dispense it to the user through the storage medium dispenser 24. The system then proceeds to step 61 where a determination is made as to whether the user has already paid at terminal 22. If YES, a receipt may be dispensed through receipt dispenser 29 at step 62. If NO (i.e., the user is paying via cashier) a price slip may be dispensed through the receipt dispenser 29 at step 64, so the user may then proceed to the cashier and pay for the customized storage medium 74. The cashier can then remove the magnetic security strip 72.

Another aspect of the present invention may include a method and system of collecting data inputted and compiled from the transaction at terminal 22, and making it available to third parties, such as copyright owners. This method may include the step of compiling data inputs at terminal 22 based on inputs and purchases made by users. The data inputted may be sent via electronic communication to data collection server 34. As stated earlier, data collection server 34 may include programs to sort and compile various information regarding the selection and purchase of the recorded material such as sales volumes, units sold, etc. Next, the collected data may be sent electronically to a special internet website 37. The website 37 may include means to protect against access by unauthorized third parties. For example, an access code or password may be provided to those third parties that may be granted access to the website. Further, access given to a particular third party may be limited to only that information related to transactions for which the user has an interest (i.e., copyright interest in the recorded material purchased). Those authorized persons, such as copyright owners, may gain access to the information compiled and communicated to internet website 37. This information may include recorded material units sold, type of storage medium sold, recorded material items previewed, sales totals, royalty payment amounts, and other desired information.

Other embodiments of the present invention may include a system configured to enable a user to customize a storage medium from their own home. This could be accomplished by providing a system available through the internet that contains stored recorded material similar to the stored material accessible through terminal 22. The user may access and then download the recorded material to a storage medium such as the hard drive of their computer, as well as to storage mediums such as CDs, DVDs and the like. This system may include many of the same capabilities as the system and methods described above. The system may include programs to allow for purchase with a credit card, debit card or other known means of payment through the internet. This system may also include the ability to collect data on the sales and selection of recorded material and then communicate that information to a data collection server 34 as described previously. The data collection server 34 may then be connected to a special internet website 37, which may be accessible only by authorized third parties (such as copyright holders). These authorized third parties may then access the information at the internet website 37. This information may include, sales data, recorded material units sold, royalty amounts, and other information pertinent to the transactions involved on the system. This system provides an improved and accurate accounting of sales of recorded material readily available to those individuals having ownership rights in the recorded material sold through the system. The system also provides a method of custom making a CD, DVD and the like while providing an accounting of the sales to copyright holders.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. A method of purchasing a customized storage medium, comprising the steps of:
accessing a terminal, said terminal having access to at least one recorded item and including at least one storage medium;
selecting at least one of said at least one recorded item;
adding said selected at least one recorded item to a list;
recording said at least one selected item to said storage medium; and
dispensing said storage medium.

2. The method of claim 1 further comprising the step of previewing said selected at least one recorded item.

3. The method of claim 1 further comprising the steps of:
designing a label; and
printing said label on one of a protective case and said storage medium.

4. The method of claim 1 further including the step of including said list on said label.

5. The method of claim 1 further comprising the step of selecting a payment type.

6. The method of claim 1 further comprising the step of affixing a magnetic strip to said case.

7. The method of claim 6 further including the step of paying a cashier.

8. The method of claim 1 further comprising the step of recording data on a data collection server.

9. The method of claim 8 further comprising the step of accessing the recorded data.

10. A system for selectively storing audio and visual recorded material onto a storage medium, comprising:
a terminal having access to recorded material and configured to download recorded material selected by a user to a storage medium; and
a dispenser connected to said terminal configured to distribute said storage medium having said selected recorded material recorded thereon.

11. The system of claim 10, wherein said terminal includes a hard drive with recorded material stored therein.

12. The system of claim 10, wherein said terminal is communicatively connected to a supply server having recorded material stored therein.

13. The system of claim 11, wherein said terminal is communicatively connected to an internet.

14. The system of claim 12, wherein said supply server is communicatively connected to an internet.

15. The system of claim 10, wherein said terminal is communicatively connected to a data collection server.

16. The system of claim 15, wherein said data collection server is communicatively connected to an internet.

17. The system of claim 16, wherein said data collection server is communicatively connected to a website accessible by third parties.

18. The system of claim 15, wherein said data collection server collects data related to quantity of sales of said selected recorded materials.

19. The system of claim 17, wherein said third parties are copyright owners.

20. A method of purchasing recorded material, comprising the steps of:
selecting at least one recorded item from a list of recorded items available for purchase;
purchasing said at least one recorded item;
collecting sales data on a server related to the quantity of sales of said at least one recorded item;
communicating said data to an internet website; and
accessing said data to determine applicable royalty payments due.
